(19) United States
(12) Patent Application Publication
(10) Pub. No.: US 2009/0212021 A1
(43) Pub. Date: Aug. 27, 2009

(54) COMPOSITIONS AND METHODS FOR SELECTIVE REMOVAL OF METAL OR METAL ALLOY AFTER METAL SILICIDE FORMATION

(75) Inventors: David D. Bernhard, Kooskia, ID (US); Weihua Wang, Fremont, CA (US); Thomas H. Baum, New Fairfield, CT (US)

Correspondence Address: MOORE & VAN ALLEN PLLC, P.O. BOX 13706, Research Triangle Park, NC, 27709, US

(73) Assignee: ADVANCED TECHNOLOGY MATERIALS, INC., Danbury, CT (US)

(21) Appl. No.: 11/917,453

(22) PCT Filed: Jun. 13, 2006
(86) PCT No.: PCT/US2006/022859

§ 371 Date: Apr. 3, 2009

Related U.S. Application Data
(60) Provisional application No. 60/690,115, filed on Jun. 13, 2005.

(51) Int. Cl. B44C 1/22; C09K 13/00; C09K 13/06; C09K 13/08

(52) U.S. Cl. 216/109; 252/79.1; 252/79.4; 252/79.3

(57) ABSTRACT

An aqueous metal etching composition useful for removal of metals such as nickel, cobalt, titanium, tungsten, and alloys thereof, after formation of metal silicides via rapid thermal annealing during complementary metal-oxide-semiconductor (CMOS) transistor fabrication. The aqueous metal etching composition is also useful for selective removal of metal silicides and/or metal nitrides for wafer re-work. In one formulation, the aqueous metal etching composition contains oxalic acid, and a chloride-containing compound, and in other formulations, the composition contains an oxidizer, such as hydrogen peroxide, and a fluoride source, e.g., borofluoric acid. The composition in another specific formulation contains borofluoric acid and boric acid for effective etching of nickel, cobalt, titanium, tungsten, metal alloys, metal silicides and metal nitrides, without attacking the dielectric and the substrate.

### FIELD OF THE INVENTION

The present invention relates to compositions and methods for removal of unreacted metal or metal alloy after metal silicide formation during a microelectronic device fabrication process. In addition, the present invention relates to compositions and methods for selective removal of metals, metal compounds and/or metal alloys used in microelectronic device fabrication for wafer re-work.

### DESCRIPTION OF THE RELATED ART

Over the last few decades, the semiconductor industry has undergone a revolution in the use of silicon-based technology to fabricate small, highly integrated electronic devices. One silicon-based microelectronic device is a metal-oxide-semiconductor (MOS) transistor, which is one of the basic building blocks of modern personal computers.

The process of forming of contacts to the gate electrode and source/drain regions of the MOS transistors is generally referred to as “metallization.” The term metallization is generic in its application, as conductive materials other than metal are commonly used for metallization. Metallization typically involves forming a protective mask on the dielectric material layer, patterning such protective mask so that the contact areas are unmasked, and etching the dielectric material layer at such unmasked areas to form openings or windows directly above the gate electrode and source/drain regions upon which the contacts are to be formed. Such openings or windows are then filled with a conductive material to form the contacts. A problem associated with this metallization process is that the contact may be misaligned with the gate electrode and source/drain regions, resulting in increased resistance at the interface. Furthermore, aligning contact windows via a separate masking step makes it difficult to further minimize the size of the source/drain regions.

Performance improvements have been obtained by solving the problems of increased resistance and misalignment through use of a silicide process, which is effective for producing low resistance contacts that are self-aligned to the desired regions.

The silicide process involves depositing a metal layer, which contains a refractory metal or metal alloy such as nickel, cobalt, titanium, tungsten and alloys thereof, over the gate electrode and source/drain regions, and heating such metal layer to a sufficiently high temperature to effectuate silicide reaction in certain areas of such metal layer where the refractory metal is in contact with a region heavily concentrated with silicon. In this manner, conductive metal silicide may be formed exclusively upon the source/drain regions and the upper surface of the polycrystalline silicon gate electrode interposed between such source/drain regions, and any unreacted metal can then be selectively removed after formation of the metal silicide.

Various refractory metals, such as nickel, cobalt, titanium, tungsten or metal alloys containing same, are commonly used for forming the metal silicide contacts. Nickel silicide (NiSi) is a particularly preferred silicide material for several reasons. A major advantage of nickel silicide is that it can be rapidly formed at relatively low temperatures, making it suitable for low temperature MOS fabrication. Other advantages of nickel silicide include no line-width dependence, reduction in “creep up” phenomenon, low resistivity, a large process window, and low silicon consumption.

A nickel layer can be effectively transformed into nickel silicide by a single-step rapid thermal anneal (RTA) process, which is carried out at temperatures in a range of from about 300° C. to about 750° C. A typical RTA process is carried out at about 550° C. for about 40 seconds in a nitrogen atmosphere. The formation of nickel silicide begins at about 250° C., when a part of the nickel layer reacts with silicon contained in the polycrystalline silicon gate electrode and the source/drain regions to form Ni₂Si. With an increase in temperature to above 300° C., the Ni₂Si reacts further with silicon to form NiSi.

After formation of NiSi in the gate electrode and source/drain regions, unreacted nickel in the nickel layer must be selectively removed. Removal of the unreacted nickel can be carried out using either plasma etching or chemical etching. Plasma etching often results in damage to the substrate surface and leaves residual trace ionic contamination. Chemical etching, on the other hand, results in less substrate damage, but the nickel etching rates using conventional chemical etchants are either very slow or not compatible with the MOS device fabrication process.

It therefore would be a significant advance in the art to provide an improved etching composition for the effective and fast removal of unreacted nickel after formation of nickel silicide through the RTA process, and which more generally removes various unreacted refractory metals and/or their alloys, such as nickel, cobalt, titanium, tungsten, titanium tungsten alloy, titanium nitride and titanium aluminum nitride, after formation of metal silicides during the MOS device fabrication process. In addition, when necessary, such an etching composition would desirably effect an efficient removal of metal silicides and/or metal nitrides, such as nickel silicide, cobalt silicide and titanium nitride for wafer re-work, provide an etching composition for selective removal of one metal or metal alloy over the others presented at MOS gate structures, and effectively remove unreacted metals, metal alloys, metal silicides and/or metal nitrides without damaging the underlying substrate surface or attacking the dielectric oxides contained therein.

### SUMMARY OF THE INVENTION

The present invention relates to compositions and methods for effective removal of unreacted metals or metal alloys after formation of metal silicides for fabrication of MOS devices, to compositions and methods for effective removal of metal silicides and/or metal nitrides for wafer re-work, and to compositions and methods for selective removal of metals or metal alloys over others present at MOS gate structures.

In one aspect, the present invention relates to an aqueous metal etching composition, comprising:
a) one or more organic acids at a concentration in a range of from about 1% to about 20% by total weight of said composition;
b) one or more chloride-containing compounds at a concentration in a range of from about 0.05% to about 15% by total weight of said composition;
c) optionally, one or more oxidizers at a concentration in a range of from about 0% to about 50% by total weight of said composition;
d) optionally, one or more fluoride-containing compound at a concentration in a range from about 0% to about 10% by total weight of said composition; and
e) optionally, one or more dielectric passivating agents at a concentration in a range from about 0% to about 10% by total weight of said composition,
wherein the composition is suitable for removing unreacted metals or metal alloys from a microelectronic device having said material(s) thereon.

In another aspect, the present invention relates to an aqueous metal etching composition that comprises oxalic acid, a chloride-containing compound, and optionally hydrogen peroxide, which is effective for removal of unreacted nickel, cobalt, and/or alloy thereof after formation of nickel silicide and/or cobalt silicide.

In still another aspect, the present invention relates to an aqueous metal etching composition that includes oxalic acid, a chloride-containing compound, hydrogen peroxide, borofluoric acid, and boric acid, which is particularly effective for removal of nickel, cobalt, titanium, tungsten and/or alloys thereof after silicide formation, without attacking the dielectric material and/or the semiconductor substrate.

In still another aspect, the present invention relates to an aqueous metal etching composition that includes oxalic acid, a chloride-containing compound, borofluoric acid, optionally hydrogen peroxide, and optionally boric acid, which is particularly effective for removal of nickel silicide, cobalt silicide, and titanium nitride, without attacking the dielectric material and/or the semiconductor substrate.

Another aspect of the present invention relates to an aqueous metal etching composition, comprising oxalic acid at a concentration in a range of from about 3% to about 9% by total weight of said composition, borofluoric acid at a concentration in a range of from about 0.2% to about 2% by total weight of said composition, hydrogen peroxide at a concentration in a range of from about 7% to about 23% by total weight of said composition, and optionally ammonium chloride at a concentration of not more than 5% by total weight of said composition, wherein the composition is suitable for removing unreacted metals or metal alloys from a microelectronic device having said material(s) thereon.

A further aspect of the present invention relates to methods for removing unreacted metals, metal alloys or metal silicides, by contacting the above-described aqueous metal etching compositions with the metals, metal alloys, metal silicides and/or metal nitrides to be removed.

Yet another aspect of the invention relates to a method for at least partially removing an unreacted metal or metal alloy selected from the group consisting of nickel, cobalt, and mixtures or alloys thereof, said method comprising contacting said unreacted metal or metal alloy with an aqueous metal etching composition at sufficient temperature and for sufficient time to effectuate at least partial removal thereof, wherein said aqueous metal etching composition comprises:
a. one or more organic acids at a concentration in a range of from about 1% to about 20% by total weight of said composition;
b. one or more chloride-containing compounds at a concentration in a range of from about 0.05% to about 15% by total weight of said composition;
c. optionally, one or more oxidizers at a concentration in a range of from about 0.1% to about 50% by total weight of said composition;
d. optionally, one or more fluoride-containing compound at a concentration in a range from about 0.05% to about 10% by total weight of said composition; and
e. optionally, one or more dielectric passivating agents at a concentration in a range from about 0.03% to about 10% by total weight of said composition.

Additional aspects of the invention variously relate to methods of manufacturing a semiconductor product including use of metal etching compositions of the invention, multi-part metal etching reagent kits for reagent compositions of the invention, precursor formulations for such reagent compositions, and methods of making such reagent compositions from precursor formulations thereof.

Other aspects, features and embodiments of the invention will be more fully apparent from the ensuing disclosure and appended claims.

### BRIEF DESCRIPTION OF THE DRAWINGS

FIG. 1 is an energy dispersive x-ray spectroscopy graph for a control sample including a NiSi film on a silicon substrate.

FIG. 2 is an energy dispersive x-ray spectroscopy graph for a sample processed with a composition of the invention at 40° C. for 15 minutes.

FIG. 3 is an energy dispersive x-ray spectroscopy graph for a control sample with a TiN film on a silicon substrate.

FIG. 4 is an energy dispersive x-ray spectroscopy graph for a sample processed with another composition of the invention at 60° C. for 15 minutes.

### DETAILED DESCRIPTION OF THE INVENTION AND PREFERRED EMBODIMENTS THEREOF

The present invention provides an aqueous metal etching composition for effective removal of unreacted metals or metal alloys, particularly nickel, cobalt, titanium, tungsten, titanium tungsten alloy, titanium nitride and/or titanium aluminum nitride, after metal silicide formation during fabrication of semiconductor devices.

The present invention also provides an aqueous metal etching composition for effective removal of metal silicides and/or metal nitrides for wafer re-work. Metal, metal alloys and metal silicides can be selectively etched away by fine tuning of the composition of the etching chemistry and the processing parameters (such as temperature and time), with no or minimum damage to substrate or dielectric material, such as silicon, silicon nitride, silicon dioxide, etc.

As defined herein, the metal silicides include silicides of nickel, cobalt, titanium, tungsten and/or alloys thereof. Specific reference to nickel and nickel silicide hereinafter is not meant to be limiting in any way and is intended to encompass the other metals and metal silicides disclosed herein.

For ease of reference, “microelectronic device” corresponds to semiconductor substrates, flat panel displays, and microelectromechanical systems (MEMS), manufactured for use in microelectronic, integrated circuit, or computer chip applications. It is to be understood that the term “microelectronic device” is not meant to be limiting in any way and includes any substrate that will eventually become a microelectronic device or microelectronic assembly.

As used herein, “about” is intended to correspond to ±5% of the stated value.

As used herein, “suitability” for unreacted metals or metal alloys from a microelectronic device having said material(s) thereon corresponds to at least partial removal of said unreacted metals or metal alloys from the microelectronic device. Preferably, at least about 90% of the material(s), more preferably at least 95% of the material(s), and most preferably at least 99% of the material(s), are removed from the microelectronic device using the compositions of the invention.

Compositions of the invention may be embodied in a wide variety of specific formulations, as hereinafter more fully described.

In all such compositions, wherein specific components of the composition are discussed in reference to weight percentage ranges including a zero lower limit, it will be understood that such components may be present or absent in various specific embodiments of the composition, and that in instances where such components are present, they may be present at concentrations as low as 0.01 weight percent, based on the total weight of the composition in which such components are employed.

Nickel is particularly difficult to remove among the metal species that can be used to form metal silicide contacts for MOS devices. Most conventional metal etchants can only achieve etching rates that are less than 100 Å/minute at etching temperatures in a range of from about 30° C. to about 50° C.

The aqueous metal etching compositions of the present invention remove nickel at a significantly faster rate than the conventional metal etchants, without damaging the underlying substrate surface or structures. Specifically, the aqueous metal etching composition of the present invention includes one or more organic acids, one or more chloride sources, and optionally one or more oxidizers.

In the broad practice of the invention, the aqueous metal etching compositions may comprise, consist of, or consist essentially of one or more organic acids, one or more chloride sources, and optionally one or more oxidizers. In general, the specific proportions and amounts of organic acid(s), chloride source(s), and optional oxidizer(s), in relation to each other, may be suitably varied to provide the desired removal action of the etching composition for the metal, metal alloys, metal silicides and/or processing equipment, as readily determinable within the skill of the art without undue effort.

The organic acid component of the composition can for example include one or more of oxalic acid, formic acid, succinic acid, malic acid, malonic acid, citric acid, dodecylbenzene sulfonic acid (DDBSA), glycolic acid, nitrilotris(methylene)triphosphoric acid (NTMTP), acetic acid, lactic acid, salicylic acid, glycine, ascorbic acid, garlic acid, phthalic acid, tartaric acid, benzoic acid, fumaric acid, mandelic acid, trifluoroacetic acid, propionic acid, aspartic acid, glutaric acid, gluconic acid, and combinations thereof. Preferably, the organic acid(s) are present in the aqueous metal etching composition at a concentration in a range of from about 1% to about 20%, more preferably from about 1% to about 10%, and most preferably from about 3% to about 9%, by weight, based on the total weight of the composition. Oxalic acid is a particularly preferred organic acid species in the practice of the present invention for effective and controlled etching of unreacted metals or metal alloys such as nickel and/or cobalt.

Although nitric acid is effective for dissolving noble metals, it has a low etch rate and a low selectivity when etching metals and metal silicides. In one aspect, the invention contemplates aqueous metal etching compositions that are devoid of nitric acid therein.

The oxidizer species useful in the metal etching compositions of the present invention can include any oxidizing compounds suitable for oxidizing the target metals or metal alloys, including but not limited to, one or more of hydrogen fluoride (HF), hydrogen peroxide (H₂O₂), ozone (O₃), perchloric acid (HClO₄), ammonium chlorite (NH₄ClO₂), ammonium chlorate (NH₄ClO₃), ammonium iodate (NH₄IO₃), ammonium perborate (NH₄BO₃), ammonium perchlorate (NH₄ClO₄), ammonium periodate (NH₄IO₃), ammonium persulfate ((NH₄)₂S₂O₈), tetramethylammonium chlorite ((N(CH₃)₄)ClO₂), tetramethylammonium chlorate ((N(CH₃)₄)ClO₃), tetramethylammonium iodate ((N(CH₃)₄)IO₃), tetramethylammonium perborate ((N(CH₃)₄)BO₃), tetramethylammonium perchlorate ((N(CH₃)₄)ClO₄), tetramethylammonium periodate ((N(CH₃)₄)IO₄), tetramethylammonium persulfate ((N(CH₃)₄)S₂O₈), tetramethylammonium hypochlorite ((N(CH₃)₄)ClO), urea hydrogen peroxide ((CO(NH₂)₂)H₂O₂), and combinations thereof. Hydrogen peroxide is a particularly preferred oxidizer species for oxidizing noble metals such as nickel. Preferably, the oxidizer is present in the aqueous metal etching composition at a concentration in a range of from about 0.1% to about 50%, more preferably in a range of from about 1% to about 30%, and most preferably in a range up to from about 7% to about 23%, by weight, based on the total weight of the composition. Hydrogen fluoride (HF) also is highly advantageous as an oxidizer species, due to its multifunctional properties as an oxidizer, its effectiveness for etching SiO₂, and its incorporation of a halogen that is highly effective in increasing solubility of metal salts, in the removal of the unreacted metal or metal alloy after metal silicide formation.

Chloride sources useful in the compositions of the invention can be any chloride-containing compounds that function to increase solubility of metal salts formed during the etching process and that prevent formation of solid deposits on the metal etching interface. Suitable chloride sources include, but are not limited to, one or more of ammonium chloride, tetramethylammonium chloride (TMACl), hydrochloric acid, benzyltrimethylammonium chloride, any other alkyl and/or aryl tertiary ammonium chloride salts, any amine hydrogen chloride salts, and combinations thereof. Hydrochloric acid is particularly preferred due to its effectiveness in preventing deposit formation and high water solubility. Preferably, the chloride source is present in the aqueous metal etching composition at a concentration in a range of from about 0.05% to about 15%, more preferably in a range of from about 0.5% to about 10%, and most preferably in a range of from about 0.5% to about 7%, by weight, based on the total weight of the composition.

The pH of the aqueous metal etching composition may be at any suitable pH level at which the resulting composition is effective and most preferably is moderately to strongly acidic. In various embodiments, the pH of the aqueous metal etching composition preferably is in a range of from about 0.1 to about 7, more preferably in a range of from about 0.2 to about 4, and most preferably in a range of from about 0.2 to about 2. Etching compositions with lower pH values, e.g., less than about 4, are particularly effective for dissolving nickel and nickel alloys.

During etching of titanium or titanium alloys, insoluble deposits of titanium dioxide tend to form on the titanium etching interface. In order to reduce formation of titanium oxide, fluoride ions can be further added to the metal etching composition. Suitable fluoride sources for such purpose can be any fluoride-containing compounds, including, but not limited to, borofluoric acid, ammonium borofluoride, hydrofluoric acid, ammonium fluoride, ammonium bifluoride, tetramethyl ammonium fluoride, tetraalkyl ammonium fluoride, any alkyl and/or aryl tertiary ammonium fluoride salts, any other amine fluoride salts, and combinations thereof. Fluoride sources when employed in the metal etching composition are preferably present in the composition at a concentration of not more than 10% by weight, and more preferably are in a range of from about 0.05% to about 5% by weight, and most preferably in a range of from about 0.05% to about 2% by weight, based on total weight of the composition.

Since fluoride ions may in some applications cause deleterious damage to the underlying dielectric oxide structures, a dielectric passivation agent may be employed when fluoride ions are present in the composition. Suitable dielectric passivation agents include, without limitation, one or more of boric acid, tetramethylammonium silicate, any silicon or silicate source, iminodiacetic acid (IDA), ethylenediaminetetraacetic acid (EDTA), (1,2-cyclohexylenedinitrilo)tetraacetic acid, hydroxyethyliminodiacetic acid, nitrilotriacetic acid, diethylenetriaminepentaacetic acid and 1,3-diaminopropanetetraacetic acid, their salts or addition compounds, and combinations thereof. The dielectric passivation agent is added to the metal etching composition to protect the dielectric oxide structures and minimizing damages caused by the fluoride attack of such dielectric oxide. The dielectric passivation agents can be present in the metal etching composition at any suitable concentration, e.g., a concentration of not more than 10% by weight, preferably not more than 5% by weight, and more preferably not more than 2% by weight, based on the total weight of the metal etching composition.

The metal etching compositions of the present application may further include various other suitable constituents. For example, one or more metal chelating compounds such as ethylenediamine tetraacetic acid (EDTA), iminodiacetic acid (IDA), cyclohexane diamine tetraacetic acid (CDTA), acetic acid, acetone oxime, alanine, arginine, asparagine, aspartic acid, benzoic acid, betaine, citric acid, dimethyl glyoxime, fumaric acid, glutamic acid, glutamine, glutaric acid, glycerol, glycine, glycolic acid, glyoxylic acid, histadine, iminodiacetic acid, isophthalic acid, itaconic acid, lactic acid, leucine, lysine, maleic acid, malic acid, malonic acid, oxalic acid, 2,4-pentanedione, phenylacetic acid, phenylalanine, phthalic acid, proline, pyromellitic acid, quinic acid, serine, sorbitol, succinic acid, terephthalic acid, trimellitic acid, trimesic acid, tyrosine, valine, xylitol, derivatives of the foregoing amino acids, and combinations thereof, can be added to the composition, for forming complexes with the dissolved metal ions and preventing metal re-deposition on the etch surface.

One or more wetting agents or surfactants, such as anionic surfactants, cationic surfactants, non-ionic surfactants, zwitterionic surfactants, or solvents such as diethylene glycol butyl ether or other glycolic ethers that are capable of lowering surface tension and improving surface wetting, can also be added to accelerate the metal etching rate. The surfactant(s) preferably are provided at a concentration that does not exceed 35% by weight, based on the total weight of the metal etching composition.

Aqueous metal etching compositions of the invention containing oxalic acid, a chloride source, and hydrogen peroxide are especially and unexpectedly effective for nickel etching. Specifically, such compositions can achieve nickel etching rates in a range of from about 2,000 Å/minute to about 6,000 Å/minute, as well as cobalt etching rates in a range of from about 10,000 Å/minute to about 30,000 Å/minute, at etching temperatures in a range of from about 30° C. to about 50° C.

Further, an aqueous metal etching composition containing oxalic acid, a chloride source, hydrogen peroxide, borofluoric acid, and boric acid has been found to be highly effective in etching nickel, cobalt, titanium and tungsten without damaging underlying dielectric oxide structures. Specifically, such compositions can achieve a titanium etching rate in a range of from about 35 Å/minute to 200 Å/minute, and a tungsten etching rate in the vicinity of about 200 Å/minute, at etching temperatures in a range of from about 30° C. to about 50° C.

In a particularly preferred embodiment of the present invention, the metal etching composition includes from about 2 wt % to about 8 wt % oxalic acid, from about 2 wt % to about 8 wt % ammonium chloride, and from about 7 wt % to about 23 wt % hydrogen peroxide, with the balance being deionized water. Such metal etching composition may further contain ammonia, and in specific embodiments of the invention, ammonia is present at concentration that is in a range in the respective embodiments of from about 0.5 to about 2 wt % in a first embodiment, from about 0.7 to about 2.1 wt % in a second embodiment, and from about 0.9 to about 2.9 wt % in a third embodiment, wherein all percentages by weight are based on the total weight of the composition.

In another preferred embodiment of the present invention, the metal etching composition includes oxalic acid at concentration of from about 2 wt % to about 8 wt %, ammonium chloride at a concentration of from about 2 wt % to about 8 wt %, borofluoric acid at a concentration of from about 0.4 wt % to about 2 wt %, optionally boric acid at concentration not exceeding 5 wt %, hydrogen peroxide at a concentration of from about 7 wt % to about 23 wt %, with the balance being deionized water, and with all weight percentages being based on the total weight of the composition.

In another preferred embodiment of the present invention, the metal etching composition includes from about 3 wt % to about 9 wt % oxalic acid, optionally not more than 5 wt % ammonium chloride, from about 0.4 wt % to about 2 wt % borofluoric acid, and from about 7 wt % to about 23 wt % hydrogen peroxide, with the balance being deionized water, and with all weight percentages being based on the total weight of the composition.

In a further preferred embodiment of the present invention, the metal etching composition includes from about 3 wt % to about 9 wt % oxalic acid, from about 0.8 wt % to about 3 wt % ammonium chloride, from about 0.4 wt % to about 2 wt % borofluoric acid, optionally not more than 2 wt % boric acid, and from about 7 wt % to about 23 wt % hydrogen peroxide, with the balance being deionized water, and with all weight percentages being based on the total weight of the composition.

In a still further embodiment of the present invention, the metal etching composition includes from about 2 wt % to about 8 wt % oxalic acid, from about 0.3 wt % to about 2 wt % hydrochloric acid, and from about 6 wt % to about 18 wt % hydrogen peroxide, with the balance being deionized water, and with all weight percentages being based on the total weight of the composition. Such metal etching composition may further contain borofluoric acid at a concentration in a range of about 0.2-1 wt % or 0.4-2 wt %, and boric acid at a concentration in a range of about 0.03-3 wt %, preferably about 0.03-1 wt %, based on the total weight of the composition.

Yet another embodiment of the invention involves a metal etching composition that includes from about 2 wt % to about 8 wt % borofluoric acid, and from about 7 wt % to about 22 wt % hydrogen peroxide, with the balance being deionized water, and with all weight percentages being based on the total weight of the composition.

Considered in total, the range of mole ratios for oxalic acid relative to chloride-containing compound(s) is about 1:0 to about 250:1, preferably about 1:3 to about 170:1, and most preferably in a range from about 1:1 to about 5:1; the range of mole ratios for oxalic acid relative to hydrogen peroxide (when present) is about 1:20 to about 1:1, preferably about 1:10 to about 1:1; the range of mole ratios for oxalic acid relative to borofluoric acid (when present) is about 1:2 to about 60:1, preferably about 1:1 to about 40:1, and most preferably about 5:1 to about 15:1; and the range of mole ratios for oxalic acid relative to boric acid (when present) is about 1:2 to about 300:1, preferably about 1:1 to about 250:1, and most preferably about 2:1 to about 70:1.

Table 1 below sets out the formulations of specific illustrative metal etching compositions having the identification (ID) designations A-Z and BA-BC.

TABLE 1

| | Oxalic | Chloride Source | | | | | | |
|---|---|---|---|---|---|---|---|---|
| ID | Acid | NH₄Cl | | HCl | H₂O₂ | HBF₄ | Boric Acid | Ammonia |
| A | — | — | | — | 15 wt % | 5 wt % | — | — |
| B | 5 wt % | 5 | wt % | — | 15 wt % | — | — | — |
| C | 5 wt % | 5 | wt % | — | 15 wt % | — | — | 1 wt % |
| D | 5 wt % | 5 | wt % | — | 15 wt % | — | — | 1.4 wt % |
| E | 5 wt % | 5 | wt % | — | 15 wt % | — | — | 1.9 wt % |
| F | 5 wt % | 5 | wt % | — | 15 wt % | 0.96 wt % | — | — |
| G | 5 wt % | 5 | wt % | — | 15 wt % | 0.96 wt % | 0.02 wt % | — |
| H | 5 wt % | 5 | wt % | — | 15 wt % | 0.96 wt % | 0.04 wt % | — |
| I | 5 wt % | 5 | wt % | — | 15 wt % | 0.96 wt % | 0.08 wt % | — |
| J | 5 wt % | 5 | wt % | — | 15 wt % | 0.96 wt % | 0.10 wt % | — |
| K | 5 wt % | 5 | wt % | — | 15 wt % | 0.96 wt % | 0.20 wt % | — |
| L | 5 wt % | 5 | wt % | — | 15 wt % | 0.96 wt % | 0.30 wt % | — |
| M | 5 wt % | 5 | wt % | — | 15 wt % | 0.96 wt % | 0.50 wt % | — |
| N | 5 wt % | 5 | wt % | — | 15 wt % | 0.96 wt % | 2.0 wt % | — |
| O | 6 wt % | — | | — | 15 wt % | 0.96 wt % | — | — |
| P | 6 wt % | 0.02 | wt % | — | 15 wt % | 0.96 wt % | — | — |
| Q | 6 wt % | 0.10 | wt % | — | 15 wt % | 0.96 wt % | — | — |
| R | 6 wt % | 0.20 | wt % | — | 15 wt % | 0.96 wt % | — | — |
| S | 6 wt % | 0.40 | wt % | — | 15 wt % | 0.96 wt % | — | — |
| T | 6 wt % | 0.80 | wt % | — | 15 wt % | 0.96 wt % | — | — |
| U | 6 wt % | 1.60 | wt % | — | 15 wt % | 0.96 wt % | — | — |
| V | 6 wt % | 3.20 | wt % | — | 15 wt % | 0.96 wt % | — | — |
| W | 6 wt % | 1.6 | wt % | — | 15 wt % | 0.96 wt % | — | — |
| X | 6 wt % | 1.6 | wt % | — | 15 wt % | 0.96 wt % | 0.05 wt % | — |
| Y | 6 wt % | 1.6 | wt % | — | 15 wt % | 0.96 wt % | 0.35 wt % | — |
| Z | 6 wt % | 1.6 | wt % | — | 15 wt % | 0.96 wt % | 1.0 wt % | — |

| | | | | | | | |
|---|---|---|---|---|---|---|---|
| BA | 4.8 wt % | — | 0.75 wt % | 12 wt % | 0.48 wt % | 0.078 wt % | — |
| BB | 4.8 wt % | — | 0.74 wt % | 12 wt % | 0.96 wt % | 0.078 wt % | — |
| BC | 4.8 wt % | — | 0.74 wt % | 12 wt % | — | — | — |

All of the metal etching compositions listed in Table 1 contain deionized water as the balance of the composition, whereby all components of the composition total to 100 weight percent.

The aqueous metal etching solutions of the present invention are also usefully employed for wafer re-work to remove metal silicides and/or metal nitrides when processed at elevated temperature and/or for a long time, with no or minimum damage to the underlying dielectric material.

In a particularly preferred embodiment of the present invention, the etching composition includes from about 3 wt % to about 9 wt % oxalic acid, from about 0.2 wt % to about 2 wt % hydrochloric acid, from about 0.2 wt % to about 2 wt % borofluoric acid, optionally hydrogen peroxide from about 0 wt % to about 23 wt %, and optionally boric acid at not more than 2 wt %, with the balance being deionized water, and with the weight percentages of all ingredients being based on the total weight of the composition, and totaling to 100 weight percent. Specifically, such compositions can achieve a nickel silicide etching rate on the order of about 17 Å/minute, a cobalt silicide etching rate on the order of about 9 Å/minute, and a titanium nitride etching rate on the order of about 9 Å/minute, at etching temperatures in a range of from about 40° C. to about 50° C.

Preferably, the aqueous metal etching compositions of the invention are substantially devoid of abrasive material, such as silica and/or alumina, polymeric particles, and heterocyclic compounds such as pyrroles, pyrazoles, imidazoles, and triazoles such as benzotriazole. As defined herein, “substantially devoid” corresponds to less than about 0.5 wt. %, more preferably less than 0.05 wt. %, and most preferably less than 0.005 wt. % of the composition, based on the total weight of said composition.

In yet another embodiment, the aqueous metal etching compositions includes one or more organic acids, one or more chloride sources, residue material, optionally one or more oxidizers, optionally one or more fluoride sources, and optionally one or more dielectric passivating agent, wherein the residue material includes nickel, cobalt, titanium, tungsten, alloys thereof, nickel silicide, cobalt silicide, titanium nitride, and combinations thereof. Importantly, the residue material may be dissolved and/or suspended in the aqueous metal etching composition of the invention.

The aqueous metal etching compositions of the invention are easily formulated by simple addition of the respective ingredients and mixing to homogeneous condition. Furthermore, the aqueous metal etching compositions may be readily formulated as single-package formulations or multi-part formulations that are mixed at or before the point of use, e.g., the individual parts of the multi-part formulation may be mixed at the tool or in a storage tank upstream of the tool. The concentrations of the respective ingredients may be widely varied in specific multiples of the aqueous metal etching composition, i.e., more dilute or more concentrated, in the broad practice of the invention, and it will be appreciated that the aqueous metal etching compositions of the invention can variously and alternatively comprise, consist or consist essentially of any combination of ingredients consistent with the disclosure herein.

Accordingly, another aspect of the invention relates to a kit including, in one or more containers, one or more components adapted to form the compositions of the invention. For example, the kit may include, in one or more containers, at least one organic acid and at least one chloride-containing compound, optionally at least one fluoride source, and optionally at least one passivating agent, e.g., as a concentrate, for combining/diluting with the oxidizing agent at the fab or the point of use in a ratio of about 1:10 to about 10:1, more preferably about 1:2 to about 4:1, and most preferably about 1:1 to about 2:1, respectively. The containers of the kit must be suitable for storing and shipping said liquid removal compositions, for example, NOWPak® containers (Advanced Technology Materials, Inc., Danbury, Conn., USA).

In etching application, the aqueous metal etching composition is applied in any suitable manner to the microelectronic device to be cleaned, e.g., by spraying the etching composition on the surface of the microelectronic device, by dipping the microelectronic device in a volume of the etching composition, by contacting the microelectronic device to be cleaned with another material, e.g., a pad, or fibrous sorbent applicator element, that is saturated with the etching composition, by contacting the microelectronic device with a circulating etching composition, or by any other suitable means, manner or technique, by which the etching composition is brought into removal contact with microelectronic device to be cleaned.

As applied to semiconductor manufacturing operations, the aqueous metal etching compositions of the present invention are usefully employed to remove unreacted nickel, cobalt, titanium, tungsten, alloys thereof, nickel silicide, cobalt silicide, titanium nitride, and combinations thereof from microelectronic device structures having such material(s) thereon.

The compositions of the present invention, by virtue of their selectivity for such metals, metal alloys and/or metal silicides, relative to other materials that may be present on the microelectronic device and exposed to the etching composition, such as dielectric layers, etc., achieve at least partial removal of the metals, metal alloys and/or metal silicides in a highly efficient manner.

In use of the compositions of the invention for removing metals, metal alloys, and/or metal suicides from microelectronic device substrates having same thereon, the etching composition typically is contacted with the device substrate for a time of from about 1 to about 60 minutes, preferably about 15 to about 30 minutes, at temperature in a range of from about 20° C. to about 80° C., preferably about 40° C. to about 60° C. Such contacting times and temperatures are illustrative, and any other suitable time and temperature conditions may be employed that are efficacious to at least partially remove the metals, metal alloys and/or metal silicides from the device substrate, within the broad practice of the invention. As defined herein, “at least partial removal” corresponds to at least 50% removal of metals, metal alloys and/or metal silicides, preferably at least 80% removal of metals, metal alloys and/or metal silicides. Most preferably, at least 90% of the metals, metal alloys and/or metal silicides is removed using the compositions of the present invention.

Following the achievement of the desired cleaning action, the etching composition is readily removed from the device to which it has previously been applied, e.g., by rinse, wash, or other removal step(s), as may be desired and efficacious in a given end use application of the compositions of the present invention. For example, the device may be rinsed with deionized water.

A still further embodiment of the invention relates to methods of manufacturing an article comprising a microelectronic device, said method comprising contacting the microelectronic device with a aqueous metal etching composition for sufficient time to remove metals, metal alloys and/or metal silicides from the microelectronic device having said materials thereon, and incorporating said microelectronic device into said article, wherein the aqueous metal etching compositions composition includes one or more organic acids, one or more chloride sources, optionally one or more oxidizers, optionally one or more fluoride sources, and optionally one or more dielectric passivating agent.

In addition, it is contemplated herein that the compositions described herein may be diluted with a solvent such as water in a ratio of about 1:1 to about 100:1 and used as a post-chemical mechanical polishing (CMP) composition to remove post-CMP residue including, but not limited to, particles from the polishing slurry, carbon-rich particles, polishing pad particles, brush deloading particles, equipment materials of construction particles, copper, copper oxides, and any other materials that are the by-products of the CMP process.

The features, aspects and advantages of the invention are more fully shown by the following specific examples of metal, metal silicide and/or metal nitride etching compositions.

### Example 1

Compositions 1-15 were made up according to the formulations in Table 2 below, wherein the percentages of the respective ingredients are by weight, based on the total weight of the composition, and wherein the weight percentages of all ingredients total to 100 weight percent.

TABLE 2

| Composition | HBF₄ | H₃BO₃ | Oxalic Acid | HCl | H₂O | H₂O₂ |
|---|---|---|---|---|---|---|
| 1 | 0 | 0 | 4.8% | 0.75% | Balance | 12% |
| 2 | 0.48% | 2.40% | | | | |
| 3 | | 1.20% | | | | |
| 4 | | 0.60% | | | | |
| 5 | | 0.30% | | | | |
| 6 | | 0.12% | | | | |
| 7 | | 0.05% | | | | |
| 8 | 1.20% | 2.40% | | | | |
| 9 | | 1.20% | | | | |
| 10 | | 0.60% | | | | |
| 11 | | 0.30% | | | | |
| 12 | | 0.12% | | | | |
| 13 | | 0.05% | | | | |
| 14 | 2.40% | 2.40% | | | | |
| 15 | | 1.20% | | | | |

The compositions were evaluated as etchants for various substrates including titanium nitride (TiN), polysilicon (Poly Si), thermal oxide dielectric material (TOX), tetraethylorthosilicate (TEOS), silicon nitride (SiN) and nickel silicide (NiSi). Each of the substrates was processed at 40° C. for 15 minutes and etch rates were determined in Angstroms per minute (Å/minute). Etch rates for all Compositions 1-15 were >5000 Å/minute on cobalt metal, and were >4000 Å/minute on nickel metal. Table 3 below shows the etch rate data.

TABLE 3

| | Etch rate, | Etch rate, | Etch rate, | Etch rate, | Etch rate, | Etch rate, |
|---|---|---|---|---|---|---|
| | A/min, on | A/min, on | A/min, on | A/min, on | A/min, on | A/min, on |
| Composition | TiN | Poly Si | TOX | TEOS | SiN | NiSi |
| 1 | 3.73 | 0.07 | 0.27 | 0.20 | 0.00 | 0.00 |
| 2 | 5.27 | 0.07 | 0.33 | 0.80 | 0.20 | 0.00 |
| 3 | 5.07 | 0.00 | 0.40 | 1.07 | 0.27 | 0.00 |
| 4 | 6.00 | 0.00 | 0.27 | 0.87 | 0.00 | 0.00 |
| 5 | 5.80 | 0.07 | 0.40 | 1.07 | 0.13 | 0.00 |
| 6 | 7.33 | 0.07 | 0.53 | 2.20 | 0.47 | >17 |
| 7 | 7.50 | 0.0 | 0.8 | 2.2 | 0.7 | >17 |
| 8 | 5.47 | 0.07 | 0.40 | 1.27 | 0.27 | 0.00 |
| 9 | 5.93 | 0.07 | 0.27 | 0.67 | 0.13 | 0.00 |
| 10 | 7.20 | 0.07 | 0.40 | 1.33 | 0.27 | 0.00 |
| 11 | 7.60 | 0.00 | 0.60 | 1.87 | 0.40 | >17 |
| 12 | 8.33 | 0.07 | 0.80 | 3.13 | 0.47 | >17 |
| 13 | 8.53 | 0.07 | 1.00 | 3.60 | 0.60 | >17 |
| 14 | 6.80 | 0.00 | 0.47 | 1.27 | 0.27 | 0.00 |
| 15 | 7.47 | 0.00 | 0.60 | 1.60 | 0.40 | 0.00 |

The data show that Compositions 1-15 achieved higher etch rates for titanium nitride and nickel silicides than for dielectric material, including polysilicon, thermal oxide, TEOS and silicon nitride. In addition, because the etch rate of Co and Ni were >5000 Å min⁻¹ and >4000 Å min^{-l}, respectively, it is possible to selectively remove the Co and Ni from the surface of the microelectronic device with minimal etching of the titanium nitride, silicide materials, and dielectric materials.

### Example 2

Energy dispersive x-ray spectroscopy studies were conducted on a silicon substrate having a film of nickel silicide thereon at a thickness of approximately 255 Angstroms.

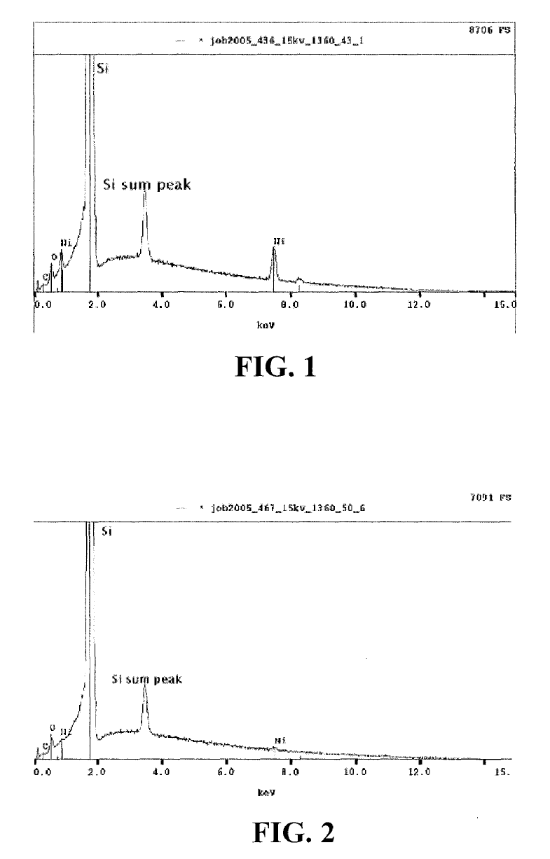

FIG. 1 is an energy dispersive x-ray spectroscopy graph for a control sample of the silicon substrate having a NiSi film thereon. Significant nickel peaks are present in the graph.

FIG. 2 is an energy dispersive x-ray spectroscopy graph for the NiSi film on silicon substrate sample, as processed with Composition 7 of Example 1 for 15 minutes at 40° C. In comparison with the graph of FIG. 1, the nickel peaks are substantially absent in the graph of FIG. 2, indicating that the NiSi film (˜255 Angstroms) has been etched away. Scanning electron microscopy (SEM) was conducted on the sample, and provided cross-sectional images that also confirmed that the NiSi layer had been removed by the etching composition.

### Example 3

Energy dispersive x-ray spectroscopy studies were conducted on a silicon substrate having a film of titanium nitride thereon at a thickness of approximately 1,000 Angstroms.

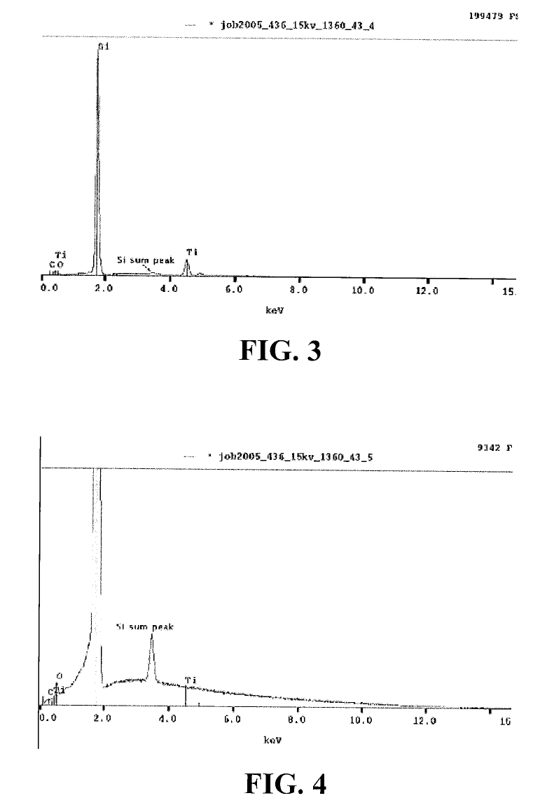

FIG. 3 is an energy dispersive x-ray spectroscopy graph for a control sample of the silicon substrate having a TiN film thereon. A significant titanium peak is observed.

FIG. 4 is an energy dispersive x-ray spectroscopy graph for the TiN film on silicon substrate sample, as processed with Composition 14 of Example 1 for 15 minutes at 60° C. In comparison with the graph of FIG. 3, the titanium peak is substantially absent in the graph of FIG. 4, indicating that the TiN film (˜1000 Angstroms) has been etched away. Scanning electron microscopy (SEM) was conducted on the sample, and provided cross-sectional images that also confirmed that the TiN layer had been removed by the etching composition.

### Example 4

Compositions 16-18 were made up according to the formulations in Table 4 below, wherein the percentages of the respective ingredients are by weight, based on the total weight of the composition, and wherein the weight percentages of all ingredients total to 100 weight percent.

TABLE 4

| Composition | HBF₄ | H₃BO₃ | Oxalic Acid | HCl | H₂O | H₂O₂ |
|---|---|---|---|---|---|---|
| 16 | 0.23 | 0.00 | 4.80 | 0.28 | Balance | 3.60 |
| 17 | 0.23 | 0.048 | 4.80 | 0.28 | | 3.60 |
| 18 | 0.46 | 0.08 | 8.00 | 0.46 | | 0.00 |

The compositions were evaluated as etchants for cobalt silicide (CoSi₂) and nickel silicide (NiSi). Each of the substrates was processed as shown in Table 5 below and etch rates were determined in Angstroms per minute (Å/minute). Table 5 below shows the etch rate data.

TABLE 5

| | | Etch rate, | Etch rate, |
|---|---|---|---|
| Composition | Process | A/min, on CoSi₂ | A/min, on NiSi |
| 16 | 50° C./30 minutes | >8.7 | |
| 17 | 50° C./30 minutes | >8.3 | |
| 18 | 40° C./15 minutes | >8.7 | >17 |

The results in Table 5 show that Compositions 16-18 evidenced good etching performance on a cobalt silicide, and that Composition 18 evidenced good etching performance on the silicide.

Although the invention has been described herein with reference to various specific aspects, features and embodiments, it will be appreciated that the invention is not thus limited, but rather extends to and encompasses other variations, modifications and embodiments, such as will suggest themselves to those of ordinary skill in the art, based on the disclosure herein. Accordingly, the invention is intended to be broadly interpreted and construed, as including all such other variations, modifications and embodiments, within the spirit and scope of the invention as hereinafter claimed.

1. An aqueous metal etching composition, comprising:
a) one or more organic acids at a concentration in a range of from about 1% to about 20% by total weight of said composition;
b) one or more chloride-containing compounds at a concentration in a range of from about 0.05% to about 15% by total weight of said composition;
c) optionally, one or more oxidizers at a concentration in a range of from about 0% to about 50% by total weight of said composition;
d) optionally, one or more fluoride-containing compound at a concentration in a range from about 0% to about 10% by total weight of said composition; and
e) optionally, one or more dielectric passivating agents at a concentration in a range from about 0% to about 10% by total weight of said composition,
wherein the composition is suitable for removing unreacted metals or metal alloys from a microelectronic device having said material(s) thereon.

2. The composition of claim 1, wherein said one or more organic acids comprise at least one organic acid selected from the group consisting of oxalic acid, formic acid, succinic acid, malic acid, malonic acid, citric acid, dodecylbenzene sulfonic acid (DDBSA), glycolic acid, nitrilotris(methylene)triphosphoric acid (NTMTP), acetic acid, lactic acid, salicylic acid, glycine, ascorbic acid, gallic acid, phthalic acid, tartaric acid, benzoic acid, fumaric acid, mandelic acid, trifluoroacetic acid, propionic acid, aspartic acid, glutamic acid, gluconic acid, and combinations thereof.

3. The composition of claim 1, wherein said one or more chloride-containing compounds comprise at least one chloride-containing compound selected from the group consisting of hydrochloric acid, tetramethylammonium chloride, ammonium chloride, benzyltrimethyl ammonium chloride, tetra alkyl ammonium chloride, aryl ammonium chloride salts, any amine hydrogen chloride salt, and combinations thereof.

4. The composition of claim 1, further comprising one or more oxidizers at a concentration in a range of from about 0.1% to about 50% by total weight of said composition, wherein said one or more oxidizers comprise at least one oxidizer selected from the group consisting of hydrogen fluoride (HF), hydrogen peroxide (H₂O₂), ozone (O₃), perchloric acid (HClO₄), ammonium chlorite (NH₄ClO₂), ammonium chlorate (NH₄ClO₃), ammonium iodate (NH₄IO₃), ammonium perborate (NH₄BO₃), ammonium perchlorate (NH₄ClO₄), ammonium periodate (NH₄IO₃), ammonium persulfate ((NH₄)₂S₂O₈), tetramethylammonium chlorite ((N(CH₃)₄)ClO₂), tetramethylammonium chlorate ((N(CH₃)₄)ClO₃), tetramethylammonium iodate ((N(CH₃)₄)IO₃), tetramethylammonium hypochlorite ((N(CH₃)₄)ClO), tetramethylammonium perborate ((N(CH₃)₄)BO₃), tetramethylammonium perchlorate ((N(CH₃)₄)ClO₄), tetramethylammonium periodate ((N(CH₃)₄)IO₄), tetramethylammonium persulfate ((N(CH₃)₄)S₂O₈), urea hydrogen peroxide ((CO(NH₂)₂)H₂O₂), and combinations thereof.

5. The composition of claim 1, comprising the fluoride-containing compound at a concentration in a range from about 0.05% to about 10% by total weight of said composition, wherein said fluoride-containing compound comprises a compound selected from the group consisting of borofluoric acid, ammonium borofluoride, hydrofluoric acid, ammonium fluoride, ammonium bifluoride, tetramethyl ammonium fluoride, tetraalkyl ammonium fluoride, alkyl tertiary ammonium fluoride, aryl tertiary ammonium fluoride salts, amine fluoride salts, and combinations thereof.

6. (canceled)

7. The composition of claim 5, comprising the dielectric passivation agent at a concentration in a range from about 0.03% to about 10% by total weight of said composition, wherein the dielectric passivating agent includes at least one agent selected from the group consisting of boric acid, tetramethylammonium silicate, any silicon or silicate source, iminodiacetic acid (IDA), ethylenediamine tetraacetic acid (EDTA), (1,2-cyclohexylenedinitrilo) tetraacetic acid, hydroxyethyliminodiacetic acid, 1,3-diaminopropanetetraacetate, nitrilotriacetic acid, diethylenetriaminepentaacetic acid, and combinations thereof.

8. The composition of claim 1, further comprising at least one metal chelating compound or at least one surfactant, wherein the at least one metal chelating agent is selected from the group consisting of ethylenediamine tetraacetic acid (EDTA), iminodiacetic acid (IDA), cyclohexane diamine tetraacetic acid (CDTA), acetic acid, acetone oxime, alanine, arginine, asparagine, aspartic acid, benzoic acid, betaine, citric acid, dimethyl glyoxime, fumaric acid, glutamic acid, glutamine, glutaric acid, glycerol, glycine, glycolic acid, glyoxylic acid, histadine, iminodiacetic acid, isophthalic acid, itaconic acid, lactic acid, leucine, lysine, maleic acid, malic acid, malonic acid, oxalic acid, 2,4-pentanedione, phenylacetic acid, phenylalanine, phthalic acid, proline, pyromellitic acid, quinic acid, serine, sorbitol, succinic acid, terephthalic acid, trimellitic acid, trimesic acid, tyrosine, valine, xylitol, derivatives of the foregoing amino acids, and combinations thereof, and wherein the at least one surfactant is selected from the group consisting of anionic surfactants, cationic surfactants, non-ionic surfactants, zwitterionic surfactants, solvents, diethylene glycol butyl ether, glycolic ethers, and combinations thereof wherein said at least one surface active agent lowers surface tension and improves surface wetting.

9. (canceled)

10. (canceled)

11. The composition of claim 1, comprising oxalic acid at a concentration in a range of from about 2% to about 9% by total weight of said composition, ammonium chloride at a concentration in a range of from about 1% to about 8% by total weight of said composition, and hydrogen peroxide at a concentration in a range of from about 0.1% to about 30% by total weight of said composition.

12. The composition of claim 11, wherein the composition further comprises ammonia at a concentration in a range of from about 0.5% to about 3% by total weight of said composition, and wherein said composition has pH in a range from about 0.2 to about 4.

13. The composition of claim 1, comprising oxalic acid at a concentration in a range of from about 2% to about 9% by total weight of said composition, ammonium chloride at a concentration in a range of from about 1% to about 8% by total weight of said composition, borofluoric acid at a concentration in a range of from about 0.2% to about 4% by total weight of said composition, hydrogen peroxide at a concentration in a range of from about 7% to about 23% by total weight of said composition, and optionally boric acid at a concentration of from 0% to about 5% by total weight of said composition.

14. (canceled)

15. The composition of claim 1, comprising oxalic acid at a concentration in a range of from about 2% to about 8% by total weight of said composition, borofluoric acid at a concentration in a range of from about 0.2% to about 2% by total weight of said composition, hydrochloric acid at a concentration in a range of from about 0.2% to about 2% by total weight of said composition, optionally boric acid at a concentration in a range of from about 0% to about 2.0% by total weight of said composition, and hydrogen peroxide at a concentration in a range of from about 6% to about 18% by total weight of said composition.

16. (canceled)

17. The composition of claim 15, comprising boric acid in a range from about 0.03% to about 2.0% by total weight of the composition.

18. (canceled)

19. The composition of claim 1, comprising oxalic acid at a concentration in a range of from about 2% to about 8% by total weight of said composition, hydrochloric acid at a concentration in a range of from about 0.2% to about 2% by total weight of said composition, and hydrogen peroxide at a concentration in a range of from about 6% to about 18% by total weight of said composition.

20. The composition of claim 1, wherein the pH of the composition is in a range from about 0.2 to about 4.

21.-25. (canceled)

26. The composition of claim 1, comprising oxalic acid, a chloride-containing compound, hydrogen peroxide, borofluoric acid, and boric acid, for etching of a metal or metal alloy selected from the group consisting of nickel, cobalt, titanium, tungsten and mixtures and alloys thereof.

27. The composition of claim 1, comprising oxalic acid, a chloride-containing compound, borofluoric acid, optionally hydrogen peroxide, and optionally boric acid, for etching of silicides and/or nitrides selected from the group consisting of nickel silicide, cobalt silicide, titanium nitride, and combinations thereof.

28. The composition of claim 27, wherein said chloride-containing compound comprises hydrochloric acid.

29. A method for at least partially removing an unreacted metal or metal alloy selected from the group consisting of nickel, cobalt, and mixtures or alloys thereof, said method comprising contacting said unreacted metal or metal alloy with an aqueous metal etching composition at sufficient temperature and for sufficient time to effectuate at least partial removal thereof, wherein said aqueous metal etching composition comprises:
a. one or more organic acids at a concentration in a range of from about 1% to about 20% by total weight of said composition;
b. one or more chloride-containing compounds at a concentration in a range of from about 0.05% to about 15% by total weight of said composition;
c. optionally, one or more oxidizers at a concentration in a range of from about 0.1% to about 50% by total weight of said composition;
d. optionally, one or more fluoride-containing compound at a concentration in a range from about 0.05% to about 10% by total weight of said composition; and
e. optionally, one or more dielectric passivating agents at a concentration in a range from about 0.03% to about 10% by total weight of said composition.

30. (canceled)

31. (canceled)

32. The method of claim 29, wherein said unreacted metal or metal alloy comprises at least one of titanium and tungsten, and wherein said aqueous metal etching composition further comprises a fluoride-containing compound.

33. The method of claim 32, wherein said fluoride-containing compound comprises at least one compound selected from the group consisting of borofluoric acid, ammonium borofluoride, hydrofluoric acid, ammonium fluoride and ammonium bifluoride, tetramethylammonium fluoride, tetraalkyl ammonium fluoride, alkyl and/or aryl tertiary ammonium fluoride salts, and amine fluoride salts.

34.-36. (canceled)

37. A multi-part metal etching reagent kit, comprising the composition as claimed in claim 1, wherein each part contains less than all components of the composition, and wherein all parts together provide the composition.

38. A precursor formulation for making of a composition as claimed in claim 1, comprising components thereof other than a complete amount of water for the composition.

39. A method of making a metal etching composition, comprising providing a precursor formulation as claimed in claim 35, and adding water thereto to produce said composition.

40. (canceled)

41. (canceled)
